(19) United States
(12) Patent Application Publication
(10) Pub. No.: US 2017/0025029 A1
(43) Pub. Date: Jan. 26, 2017

(54) SYSTEM AND METHOD FOR DEVELOPING AND EVALUATING SITUATIONAL JUDGMENT TEST

(71) Applicant: Varun AGGARWAL, Gurgaon, Haryana (IN)

(72) Inventors: Varun AGGARWAL, Gurgaon (IN); Himanshu AGGARWAL, Gurgaon (IN)

(73) Assignee: Varun AGGARWAL, Gurgaon, Haryana (IN)

(21) Appl. No.: 15/112,681

(22) PCT Filed: Dec. 18, 2014
(86) PCT No.: PCT/IB2015/059768

§ 371 Date: Jul. 19, 2016

(30) Foreign Application Priority Data
Dec. 19, 2014 (IN) 3776/DEL/2014

(51) Int. Cl. G09B 7/00; G09B 19/00

(52) U.S. Cl. CPC G09B 7/00; G09B 19/00

(57) ABSTRACT

System and method for developing and evaluating situational judgment is disclosed. The method includes the steps of creating content for one or more test situations; creating one or more options to address each of the one or more situations; posting the one or more test situations and one or more options to address each of the one or more situations to an online crowdsourcing platform; receiving responses by the plurality of respondents through the online crowdsourcing platform and normalizing the received responses wherein the normalization is done based on aggregation of responses by the plurality of respondents.

### CROSS-REFERENCE TO RELATED APPLICATIONS AND PRIORITY

The present application claims priority from an Indian Patent Application No. 3776/DEL/2014 filed on 19 Dec. 2014.

### TECHNICAL FIELD

The present disclosure in general relates to situational judgment tests. More particularly, the present disclosure relates to a system and method for developing and evaluating situational judgment test.

### BACKGROUND

Personnel selection is a methodical process often used to hire or recruit skilled individuals. An effective personnel selection method follows a structured framework in which each individual is asked a set of questions and answers are evaluated and the individual is scored with a standardized rating scale. One such method includes developing situational judgment tests (SJTs).

Generally, situational judgment tests (SJTs) comprises written descriptions, audio and/or video descriptions of job relevant situations. Such situations are typically derived from the job analysis which includes collecting information on critical incidents. Such critical incidents are used to develop different situations (job related situations) where judgments of the prospective individual would need to make a decision. Once the situations are developed, the scenarios are presented to a first set of subject matter experts and the first set of subject matter experts are asked to suggest effective and less effective solutions to the situation. Further, a second set of subject matter experts are asked to rate the responses/suggestions from best to worst. The responses may be short answers, however, more typically the participants are given a finite number of potential responses and asked to rate the quality of the response option from best to worst. Then the test is scored with the highest ranked options giving the respondent the higher score.

The SJTs are generally been used to determine behavioral tendencies, assessing how an individual will behave in a certain situation, practical intelligence and the individual's interaction skills among other things etc. For example, in a situational judgment tests, one or more situations are provided with a set of options for each situation and an individual (test taker) is asked to choose one or more right way of handling the situations. On the other hand, the test-taker may also be asked to rank the options for each situation according to their suitability in handling the given situation. Then the test is scored on based on whether the individual chosen the correct option for the right way to handle the situation. The choice of situation depends on the skill the individual is being tested for. Hence the SJTs are used for various purposes including recruitment, counseling etc.

The conventional method of developing SJTs are manual and achieved by taking input from high performers/experts in the given role/company. Consequently, one is not able to develop standardized situational judgment tests.

### SUMMARY OF THE INVENTION

This summary is provided to introduce aspects related to system(s) and method(s) for developing and evaluating situational judgment test and capability evaluation using crowdsourcing and the aspects are further described below in the detailed description. This summary is not intended to identify essential features of the claimed subject matter nor is it intended for use in determining or limiting the scope of the claimed subject matter.

The present disclosure relates to a system and method for developing and evaluating situational judgment. The primary object of the present disclosure is to provide a system and method for developing and scoring situational judgment test through crowdsourcing and hence for capability evaluation of a participant/test-taker.

These and the other objects of the present disclosure are achieved by the system comprising a question management module that includes content for one or more test situations and associated one or more options to address each of the one or more situations; a crowd management module for posting the one or more test situations and for receiving responses by plurality of respondents, a feedback and review module for assessing the quality of the test situation and a scoring module for normalization of the received responses, wherein the question management module, the crowd management module and the scoring module are implemented on one or more cloud servers.

In embodiments, a method for developing and evaluating situational judgment test is described, the method comprising; creating content for one or more test situations wherein the test situations include job relevant situations derived from job analysis; creating one or more options to address each of the one or more situations wherein the one or more options include one or more possible ways of handling the situation; posting the one or more test situations and one or more options to address each of the one or more situations to an online crowdsourcing platform wherein the online crowdsourcing platform allows plurality of respondents to respond to said one or more test situations; receiving responses by the plurality of respondents through the online crowdsourcing platform; and normalizing the received responses wherein the normalization is done based on aggregation of responses by the plurality of respondents.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 is a network implementation 100 of system 102 for developing and scoring situational judgment test and hence for capability evaluation using crowdsourcing is disclosed.

FIG. 2 is a block diagram of an example system for developing and scoring situational judgment test in accordance with an embodiment of the present disclosure.

### DETAILED DESCRIPTION

While aspects of described system and method, for developing and scoring situational judgment test and hence for capability evaluation using crowdsourcing may be implemented in any number of different computing systems, environments, and/or configurations, the embodiments are described in the context of the following exemplary system. The present disclosure relates to the system and method for developing and scoring situational judgment test and hence for capability evaluation using crowdsourcing.

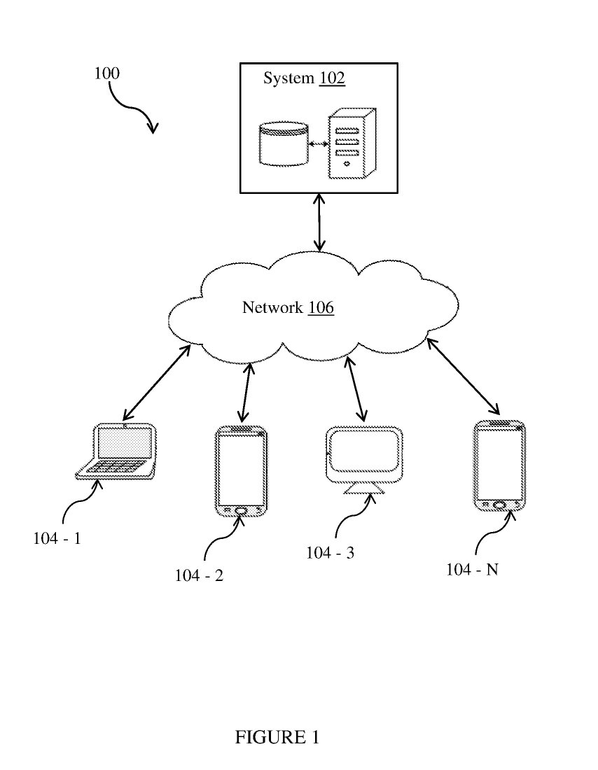

Referring now to FIG. 1, a network implementation 100 of system 102 for developing and scoring situational judgment test and hence for capability evaluation using crowdsourcing is disclosed. In one embodiment of the present disclosure, one or more test situations and one or more options to address each of the one or more situations or in other words, a set of possible ways of handling situations are provided to a plurality of users, now referred to as crowd/respondents, through a crowdsourcing platform. Further, the respondents are interactively triggered to rank the effective way of handling the situation and/or to mark the best and/or the worst way of handling the situations and the responses are collected for normalization. In one embodiment of the present disclosure, in addition to the responses, the responders' demographic profile/data are captured such as country, occupation, designation, years of experience etc. The received responses and the demographic profiles are used to build norms for situational judgment test after balancing for sampling errors. It is to be noted that in the current disclosure, the terms ‘situation’ and ‘test situation’ are used interchangeably to refer to the content of the situational judgement test provided to the respondents.

Still referring to FIG. 1, although the present subject matter is explained considering that the system 102 is implemented as an application on a server. The system may also include one or more servers for implementing the application. The server comprises an advertisement server, an identification server, a work server and an identity management server.

It may be understood that the system 102 may also be implemented in a variety of computing systems, servers, workstations, network servers and alike. In one implementation, the system 102 may be implemented in a cloud-based environment. The system may comprise one or more servers. The server may comprise a mobile vehicle station server, and a location server. The components and modules of the server are implemented as software and/or hardware components, such as a field programmable gate array (FPGA), an application specific integrated circuit (ASIC), and the like which performs certain tasks.

It will be understood that the system 102 may be accessed by multiple users/respondents through one or more user devices 104-1, 104-2 . . . 104-N, the user devices 104 collectively referred to as user device 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

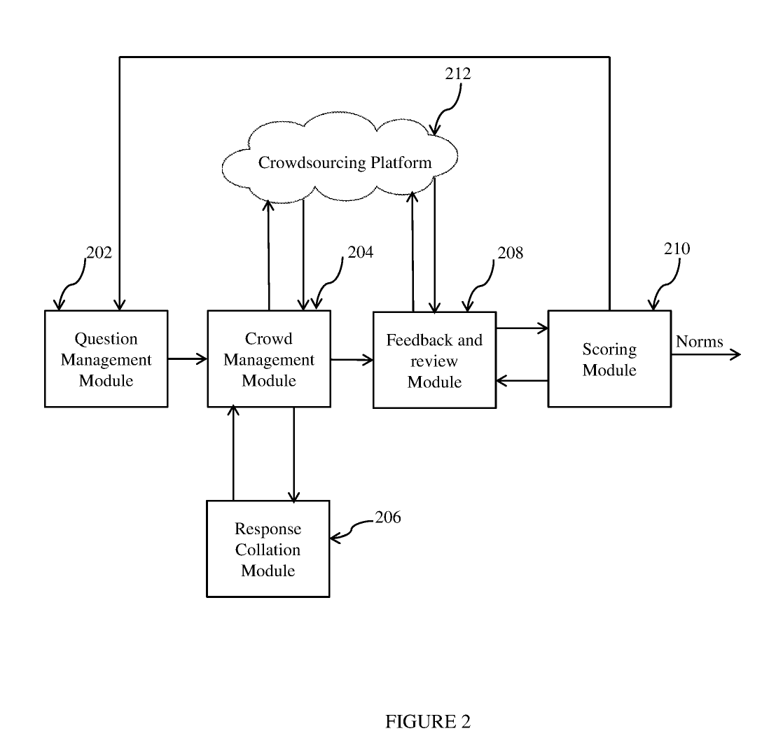

FIG. 2 is a block diagram of an example system for developing and scoring situational judgment test in accordance with an embodiment of the present disclosure. As shown, the system 102 comprises a question management module 202, a crowd management module 204, a response collation module 206, a feedback and review module 208, at least one scoring module 210 and a crowdsourcing platform 212.

In one embodiment of the present disclosure, a situational judgment test comprising one or more situations and one or more options to address each of the one or more situations are created and updated to the question management module 202. The test situations include job relevant situations derived from job analysis for example a critical situation faced in a particular job role for instance, sales or customer service, and the one or more options include one or more possible ways of handling the situation.

The question management module 202 facilitates organizations (may include employer, administrator and others) to input, define and document assessment content for one or more test situations wherein the assessment content may include textual content, audio content and/or video content. The organizations may input or communicate assessment content through any suitable input device or input mechanism such as but not limited to a keyboard, a mouse, a touchpad, a virtual keyboard and suitable application. Further, the question management module 202 provides shared repositories enabling multiple subject experts to work collaboratively to build the situational judgment tests. In one embodiment of the present disclosure, the question management module 202 organizes, stores and secures the assessment content. In another embodiment, the question management module 202 comprises one or more options to address each of the one or more situations wherein the one or more options may include possible best and/or worst ways of handling the situations.

The crowd management module 204 is built to manage and post the assessment content (one or more test situations) and the one or more associated options to address each of the one or more situations. The crowd management module 204 connects the system with large scale population of users/respondents through the crowdsourcing platform 206. Further, the crowd management module 204 is configured to receive responses from the plurality of respondents. In one embodiment of the present disclosure, the crowd management module 204 is configured to receive reasons and thought process behind choosing at least one of the best or worst possible way of handling the situation and respondents' demographic profile.

In one embodiment, the crowdsourcing platform 212 is an internet platform that enables the organizations and the plurality of respondents to coordinate to develop situational judgment tests. The plurality of respondents may access the crowdsourcing platform 212 through the user devices (104) to respond to the situational judgment tests. The crowd management module 204 receives the responses and demographic profiles and forwards the received data to the response collation module 206, the feedback and review module 208 and to the scoring module 210. The demographic profile may include respondent country (geographical area), gender, qualification, occupation, designation, experience etc. In another embodiment, the functions of crowdsourcing platform 212 can be implemented through social networking platforms such as Facebook, Twitter etc.

The response collation module 206 receives the responses and demographic profiles and organizes in a response collation database based on pre-defined one or more criteria wherein the pre-defined one or more criteria may include organizing the responses for a set of situational judgment tests, organizing based on demographic profiles and the alike. In one embodiment of the present disclosure, the response collation module 206 analyses the reliability of the responses based on one or more pre-defined conditions. The response collation module 206 performs reliability analysis to ensure that the respondents are not responding perfunctorily. For example, for a test containing a set of 10 questions/situations, best and worst solutions for 4 situations are fed to the response collation module 206. On receiving the responses from the plurality of respondents, the response collation module 206 compares the responses from the each individual respondent with the know solution and if all or a pre-defined percentage of responses are not matching with the know solutions then the respondent is tagged as unreliable.

The system for developing and evaluating situational judgement test in accordance with various embodiments of the present disclosure further comprises a feedback and review module 208. The responses received from the crowd management module 204 are assessed at the feedback and review module 208 in order to identify and assess one or more of alternative responses proposed by the respondents, i.e. the responses that do not correspond to any of the options to address the test situations provided to the respondent. The alternative responses thus received are assessed and quantified to obtain feedback on the test situation such as the correctness of the test situation, the commonality of the test situation among the respondents, the language and presentation of the test situation and the like. The feedback thus received is forwarded to the scoring module 210 and the question management module 202 for modifying the test situations where necessary.

For example, if 50 out of 100 respondents to a sample test situation do not respond with any of the one or more options provided to the respondent, the respondents are provided with another option to provide at least a feedback. In one embodiment, the respondent feedback is received in the form of comments on at least one of the parameters such as correctness of the one or more options provided for the test situation, the commonality of the one or more options, language and presentation of the provided test situation and the like. In another embodiment, the parameters as described above are provided as options to the respondent and the corresponding response is recorded at the crowd management module 204 and forwarded to the feedback and review module 208 for assessment.

At the feedback and review module 208, for each test situation the feedback received from the respondents on the one or more parameters of the test situation are assigned a weight and based on the collective weights, a quality score is provided for each test situation. The quality score along with the feedback are forwarded to the scoring module 210.

In one embodiment of the present disclosure, the scoring module 210 receives the situations and responses along with the demographic profile and aggregates the received responses to determine best and/or worst options for each situation and accordingly develops a situational judgment test.

For example, if “100” respondents have responded for a test containing “10” questions/situations, the scoring module 210 selects the first situation and determines the best and/or worst option for that particular situation. The best and/or worst option for that particular situation is determined by identifying the responses from the plurality of respondents. If the first situation contains three options (option a, b and c) and “80” respondents selected option “a” as the best option for that particular situation, then the scoring module 210 determines option “a” as the best option. Similarly, the scoring module 210 determines the best and/or worst option for all the “10” situations based on the responses from “100” respondents and creates an answer database for further processing. Hence the answer database comprises options/answers having maximum weightage for each of the test situations. The weightage as described herein refers to the quantum of responses received corresponding to one or more options/answers. It has to be noted that the answer database may contain best, worst or best and worst options for a particular situation based on the assessment content. Further, if the answer is not predictable for one or more situations, then the test is posted back to the crowd for verification with or without modifying the test situations.

In another embodiment of the present disclosure, the scoring module 210 performs normalization for capability evaluation of participants/test-takers. The manner in which the scoring module 210 performs capability evaluation is described in detail further below.

Initially, the scoring module 210 creates score for the each respondents by comparing the responses/options from the respondents for each test situation with the know option from the answer database. In one embodiment of the present disclosure, for each response of a respondent the score is created based on the options selected by the respondent. For example, a “+1” score is assigned if the respondent selected a correct option and “0” is created for a wrong option. It has to be noted that the scoring may be done based on other criteria such as a “4” score may be created if the respondent selects option “worst” instead of selecting “best” option for a situation, a score of “+0.5” may be created if the respondent select other than the best or worst option etc.

Once the score is created for each response, a weighted score is calculated by adding all the scores for that particular respondent. Similarly, the weighted score is calculated for all the respondents for that particular test and a reference weighted score (average score) is determined for a desired percentile value for example “80%”.

In another embodiment, the normalization of the responses at the scoring module 210 is performed using other known methods such as z-scores, t-scores and the like.

In one embodiment of the present disclosure, in order to evaluate the capability of a participant/test-taker, the weighted score of the participant is calculated in the same manner as described above and the weighted score is compared with the reference weighted score derived from the plurality of respondents/crowd.

In one implementation, the system may be implemented to develop and evaluate situational judgment tests based on the demographic profiles. For example, to develop a situational judgment test for a particular job role for example “technical analyst”, the responses from the respondents having “technical analyst” designation may be filtered by analyzing the demographic profile of the respondents.

In another implementation, the system may be implemented in a manner whereby the respondents/crowd may be asked to contribute critical situations faced in a particular job role wherein the job description is posted as a situations and the responses regarding the critical situations are analyzed by a subject matter expert to develop situational judgment tests.

Hence, the system and method for developing and evaluating situational judgment test disclosed in the present disclosure enables organizations or any employers to build situational judgment tests by precisely identifying the best and worst options to handle one or more situations. Further, the method and system minimizes the human intervention for developing and evaluating situational judgment tests.

The written description describes the subject matter herein to enable any person skilled in the art to make and use the embodiments of the invention. The scope of the subject matter embodiments are defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

We claim:

1. A system for developing and evaluating situational judgment test, the system comprising:
a question management module comprising content for one or more test situations and associated one or more options to address each of the one or more situations;
a crowd management module for posting the one or more test situations to a crowdsourcing platform wherein the crowdsourcing platform allows a plurality of respondents to respond to said one or more test situations; and
a scoring module for normalization of the received responses, wherein the question management module, the crowd management module and the scoring module are implemented on one or more cloud servers.

2. The system of claim 1 wherein the content for one or more test situations includes textual content, audio content and video content describing the one or more test situations wherein the test situations include job relevant situations derived from job analysis.

3. The system of claim 1 wherein the one or more options to address each of the one or more test situations includes one or more possible ways of handling the situation.

4. The system of claim 1 wherein the responses by the plurality of respondents include at least one of the best or worst possible ways of handling the situation.

5. The system of claim 1 wherein the responses received from the plurality of respondents include reasoning and thought process behind choosing at least one of the best or worst possible way of handling the situation and at least the respondents demographic profiles.

6. The system of claim 1 wherein the responses received from the plurality of respondents include alternative responses proposed by the respondents other than the one or more options to address each of the one or more situations in one of a subjective or objective form.

7. The system of claim 1 wherein the scoring module comprises a feedback and review module configured to receive the one or more alternative responses proposed by the respondents and wherein the one or more alternative responses comprises a feedback to the one of test situation, the language of the test situation, frequency of the test situation and the like.

8. A method for developing and evaluating situational judgment test, the method comprising:
creating content for one or more test situations wherein the one or more test situations include job relevant situations derived from job analysis;
creating one or more options to address each of the one or more situations wherein the one or more options include one or more possible ways of handling the situation;
posting the one or more test situations and one or more options to address each of the one or more situations to an online crowdsourcing platform wherein the online crowdsourcing platform allows plurality of respondents to respond to said one or more test situations;
receiving one or more responses for one or more test situations by the plurality of respondents through the online crowdsourcing platform;
receiving demographic profiles of the plurality of respondents wherein demographic profile of plurality of respondents include geographical area, gender, qualification, occupation, designation and experience; and
normalizing the received one or more responses wherein the normalization is done based on aggregation of responses by the plurality of respondents.

9. The method of claim 8 wherein the normalization is done based on demographic profiles of the plurality of respondents.

10. The method of evaluating capability of a participant wherein the method comprises of steps as recited in claim 8 followed by the steps of:
creating an answer database wherein the answer database includes options having maximum weightage for each of the test situations;
creating score for the plurality of respondents and participant wherein the score is created by comparing the responses from each respondent and participant with the option from the answer database;
calculating weighted score for plurality of respondents and participant wherein the weighted score is calculated by adding all the scores for particular respondent and participant;
selecting a reference weighted score from the plurality of weighted score of the plurality of respondents; and
evaluating capability of the participant wherein the capability is evaluated by comparing the weighted score of the participant with the reference weighted score.
